(19) United States
(12) Patent Application Publication
(10) Pub. No.: US 2025/0062830 A1
(43) Pub. Date: Feb. 20, 2025

(54) COMMUNICATION SYSTEM AND METHOD OF OPERATING COMMUNICATION SYSTEM

(71) Applicant: Sony Group Corporation, Tokyo (JP)

(72) Inventor: Tuo ZHUANG, Tokyo (JP)

(73) Assignee: Sony Group Corporation, Tokyo (JP)

(21) Appl. No.: 18/725,232

(22) PCT Filed: Dec. 20, 2022
(86) PCT No.: PCT/JP2022/046798

§ 371 Date: Jun. 28, 2024

(30) Foreign Application Priority Data
Jan. 5, 2022 (JP) 2022-000399

(51) Int. Cl. H04B 10/116

(52) U.S. Cl. CPC H04B 10/116

(57) ABSTRACT

There is provided a communication system and a method of operating the communication system capable of causing the amount of information transferred in visible light wireless communication to be increased easily at low cost. A transmission unit of a visible light communication system controls the light emission of a plurality of light-emitting elements that emit light in different wavelength bands based on a transmission signal, and a reception unit detects using a snapshot-type spectroscopic camera an optical spectra of the light emitted by the light-emitting unit, and restores the transmission signal based on light emission intensities in wavelength bands respectively corresponding to the plurality of light-emitting elements in the detected optical spectrum. The present disclosure can be applied to visible light communication systems.

### TECHNICAL FIELD

The present disclosure relates to a communication system and a method of operating the communication system, and more particularly to a communication system and a method of operating the communication system capable of causing an increase in the amount of information transferred in visible light wireless communication at low cost.

### BACKGROUND ART

In the field of optical communications, there is visible light wireless communication technology that uses light bulbs and light emitting diodes (LEDs).

This visible light wireless communication can express two bits of information by switching a light source on and off, which is observed with a camera to read the information.

In addition, a large amount of information can be transmitted by switching the light source on and off at high speed in accordance with the frame rate of the camera for observation.

Such visible light communication systems are currently mainly used for ID identification in factories, offices, and the like.

For example, there has been proposed a technology in which, in order to monitor the status of devices/equipment in operation in a factory, LEDs which are warning lights attached to the respective pieces of equipment are configured as transmission units, and fixed-point cameras that can overlook the entire factory are installed to detect in which equipment a problem is occurring (see NPL 1).

In other words, with this configuration, when a problem occurs in any of the pieces of equipment, the corresponding LED transmits the ID information of the equipment with visible light, and accordingly, the fixed-point camera receives the bit string transmitted with visible light from the LED, making it possible to detect in which equipment the problem is occurring.

However, in the technology described in NPL 1, since the on and off of the light source is used as a method of expressing information, only one bit of information can be transmitted at a time, which results in a small amount of information transferred.

In response to this, a technology has been proposed that applies a technology to enable wireless communication underwater, where it is difficult to use radio waves, specifically in which on the transmitting side, LEDs in the three colors of visible light (red, blue, and green) are used to transmit three bits of information at a time, and on the receiving side, cameras using photodiodes specialized for the respective RGB colors are installed, to make the amount of information transmitted three bits, that is, to increase the amount of information transmitted by three times (see NPL 2).

### CITATION LIST

### Non Patent Literature

NPL 1: https://picalico.casio.com/ja/sp/use1.html
NPL 2: https://www.ieice.org/˜wbs/pdf/taikai_LinXin.pdf

### SUMMARY

### Technical Problem

In the visible light wireless communication, the amount of information transmitted may be increased by increasing both the light emission rate on the transmitting side and the frame rate of the cameras on the receiving side, that is, by increasing the transmission and reception rates of bit information.

However, with this method, the light emission rate or the frame rate of each camera are each limited, which is the rate limiting factor, that is, limits the possible increase in the amount of information transferred. In addition, with this method, the costs of the LEDs and cameras also increase, and accordingly, the cost of the visible light communication system increases as a whole.

As in NPL 2, a larger number of bits of information may be transmitted at a time by subdividing the wavelength band of visible light to be used and adding different bit information to different wavelengths.

However, typical cameras currently used only have sensitivity characteristics to the three RGB wavelengths, and even if the band is divided into a larger number of bands on the transmitting side, general cameras cannot detect them.

The present disclosure has been made in view of such circumstances, and is particularly intended to increase the amount of information transferred in visible light wireless communication at low cost.

### Solution to Problem

A communication system according to one aspect of the present disclosure is a communication system including a transmission unit and a reception unit, wherein the transmission unit includes: a light-emitting unit that has a plurality of light-emitting elements that emit light in different wavelength bands, the light-emitting unit controlling light emission of the plurality of light-emitting elements; and a signal generation unit that generates as a control signal a signal to control the light emission of the plurality of light-emitting elements based on a transmission signal and supplies the control signal to the light-emitting unit, and the reception unit includes: a snapshot-type spectroscopic camera that detects an optical spectrum of light emitted by the light-emitting unit; and a restoration unit that restores the transmission signal based on light emission intensities in wavelength bands respectively corresponding to the plurality of light-emitting elements in the optical spectrum detected by the snapshot-type spectroscopic camera.

A method of operating a communication system according to one aspect of the present disclosure is a method of operating a communication system including a transmission unit and a reception unit, wherein the transmission unit includes: a light-emitting unit that has a plurality of light-emitting elements that emit light in different wavelength bands, the light-emitting unit controlling light emission of the plurality of light-emitting elements; and a signal generation unit that generates as a control signal a signal to control the light emission of the plurality of light-emitting elements based on a transmission signal and supplies the control signal to the light-emitting unit, and the reception unit includes: a snapshot-type spectroscopic camera that detects an optical spectrum of light emitted by the light-emitting unit; and a restoration unit that restores the transmission signal based on light emission intensities in wavelength bands respectively corresponding to the plurality of light-emitting elements in the optical spectrum detected by the snapshot-type spectroscopic camera, wherein a method of operating the transmission unit includes: generating, by the signal generation unit, as a control signal a signal to control the light emission of the plurality of light-emitting elements based on the transmission signal, and supplying the control signal to the light-emitting unit; and controlling, by the light-emitting unit, light emission of the plurality of light-emitting elements based on the control signal, and wherein a method of operating the reception unit includes: detecting, by the snapshot-type spectroscopic camera, an optical spectrum of light emitted by the light-emitting unit; and restoring, by the restoration unit, the transmission signal based on light emission intensities in wavelength bands respectively corresponding to the plurality of light-emitting elements in the optical spectrum detected by the snapshot-type spectroscopic camera.

In one aspect of the present disclosure, in a transmission unit, by a light-emitting unit that has a plurality of light-emitting elements that emit light in different wavelength bands, light emission of the plurality of light-emitting elements is controlled, and a signal to control the light emission of the plurality of light-emitting elements is generated as a control signal based on a transmission signal and is supplied to the light-emitting unit; and in a reception unit, an optical spectrum of light emitted by the light-emitting unit is detected, and the transmission signal is restored based on light emission intensities in wavelength bands respectively corresponding to the plurality of light-emitting elements in the detected optical spectrum.

### BRIEF DESCRIPTION OF DRAWING

FIG. 1 is a diagram illustrating the communication principle of a visible light communication system.

FIG. 2 is a diagram illustrating a configuration example of a visible light communication system according to a first embodiment of the present disclosure.

FIG. 3 is a diagram illustrating a configuration example of a light-emitting unit in FIG. 2.

FIG. 4 is a diagram illustrating wavelength bands of light emitted by each light-emitting element of the light-emitting unit in FIG. 2.

FIG. 5 is a diagram illustrating an example of a transmission signal transmitted by a transmission unit in FIG. 2.

FIG. 6 is a diagram illustrating a method of transmitting a transmission signal by the transmission unit in FIG. 2.

FIG. 7 is a diagram illustrating a three-dimensional spectral image data set (data cube).

FIG. 8 is a diagram illustrating an example of extracting a spectral intensity distribution at the position of the light-emitting unit from the three-dimensional spectral image data set (data cube).

FIG. 9 is a diagram illustrating a method of generating a binary bit string from an extracted spectral intensity distribution.

FIG. 10 is a flowchart illustrating transmission processing by the transmission unit in FIG. 2.

FIG. 11 is a flowchart illustrating reception processing by a reception unit in FIG. 2.

FIG. 12 is a diagram illustrating a configuration example of a visible light communication system according to a second embodiment of the present disclosure.

FIG. 13 is a diagram illustrating a configuration example of a light emitting unit in FIG. 12.

FIG. 14 is a diagram illustrating wavelength bands of light emitted by each light emitting element of the light emitting unit in FIG. 12.

FIG. 15 is a diagram illustrating an example of a transmission signal transmitted by a transmission unit in FIG. 12.

FIG. 16 is a diagram illustrating a method of transmitting a transmission signal by the transmission unit in FIG. 12.

FIG. 17 is a diagram illustrating a method of generating reception light signals from an extracted spectral intensity distribution.

FIG. 18 is a diagram illustrating a method of restoring reception signals from the extracted spectral intensity distribution.

FIG. 19 is a flowchart illustrating transmission processing by the transmission unit in FIG. 12.

FIG. 20 is a flowchart illustrating reception processing by a reception unit in FIG. 12.

FIG. 21 is a diagram illustrating a configuration example of a general-purpose personal computer.

### DESCRIPTION OF EMBODIMENTS

Preferred embodiments of the present disclosure will be described below in detail with reference to the accompanying drawings. In the present specification and the drawings, components having substantially the same functional configuration will be denoted by the same reference numerals, and thus repeated descriptions thereof will be omitted.

Embodiments for implementing the present technology will be described below. The description will be made in the following order.
1. Communication Principles of Visible Light Wireless Communication System
2. First Embodiment
3. Second Embodiment
4. Software-performed Example

### 1. Communication Principle of Visible Light Wireless Communication System

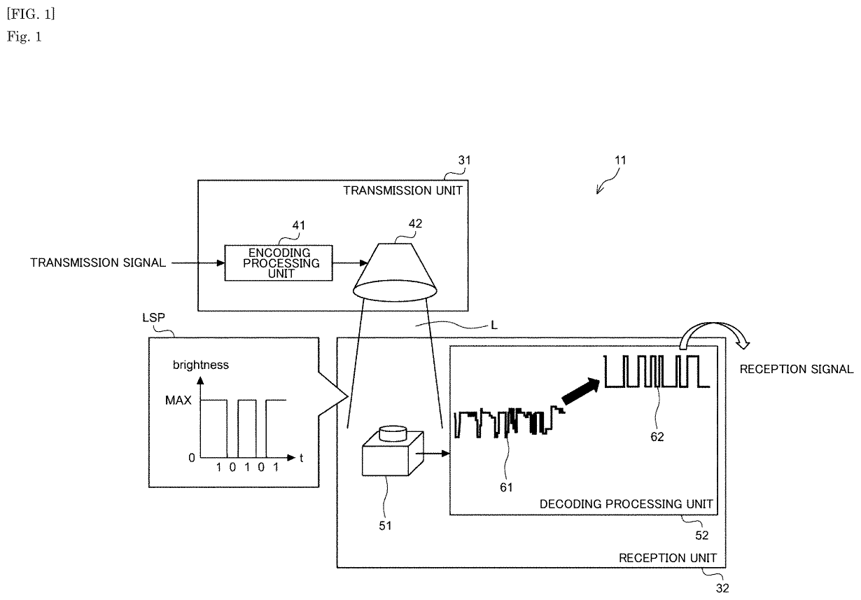

The communication principle of a visible light wireless communication system will be described with reference to FIG. 1.

The visible light wireless communication system 11 in FIG. 1 includes a transmission unit 31 and a reception unit 32.

When the transmission unit 31 acquires a transmission signal, the transmission unit 31 encodes the transmission signal into encoded information consisting of a binary bit string, and based on the encoded information, controls the on/off of a light-emitting unit including a light emitting diode (LED) or the like to transmit the encoded information by emitting and extinguishing visible light.

More specifically, the transmission unit 31 includes an encoding processing unit 41 and a light-emitting unit 42. In response to receiving the input of a transmission signal, the encoding processing unit 41 encodes the transmission signal into an encoded signal made up of a binary bit string.

Then, the encoding processing unit 41 controls in time series the on/off of the light-emitting unit 42 that emits visible light, such as an LED, based on the encoded signal made up of the binary bit string.

For example, as indicated in a timing chart LSP, for 1 in an encoded signal made up of a binary bit string, the encoding processing unit 41 turns on the light-emitting unit 42 to emit light (set the brightness to Max).

On the other hand, for 0 in the encoded signal, the encoding processing unit 41 turns off the light-emitting unit 42 to extinguish the light (set the brightness to 0).

The light-emitting unit 42 transmits the encoded information as a visible light signal L by on/off emission control of the light-emitting unit 42.

The reception unit 32 receives the visible light signal transmitted from the transmission unit 31 in time series, generates an encoded signal based on the light emission/extinction pattern of the visible light signal received in time series, further decodes the encoded signal to restore the transmission signal, and outputs the resulting transmission signal as a reception signal.

More specifically, the reception unit 32 includes a light receiving unit 51 and a decoding processing unit 52.

The light receiving unit 51 includes, for example, photodiodes, and outputs a time series observation result of the received light level of the light emitted from the light-emitting unit 42 of the transmission unit 31 to the decoding processing unit 52 as waveform data such as that indicated by a waveform 61.

When the decoding processing unit 52 acquires the waveform 61, which is a time-series observation result of the received light level corresponding to on or off of the light-emitting unit 42 of the transmission unit 31 and which is supplied from the light receiving unit 51, the decoding processing unit 52 wave-shapes the waveform 61 into, for example, a binary rectangular waveform 62 by comparing the waveform 61 with a predetermined threshold value.

Then, the decoding processing unit 52 generates an encoded signal made up of a binary bit string based on the binary rectangular waveform 62, and decodes the generated encoded signal to restore a reception signal corresponding to the transmission signal, and outputs the reception signal.

Specifically, in the visible light wireless communication system 11, the transmission unit 31 converts a transmission signal into an encoded signal made up of a binary bit string, and based on the encoded signal made up of the binary bit string, and controls the on and off of the light-emitting unit 42 in time series to transmit the encoded signal as a flashing light signal L.

The reception unit 32 receives the flashing light signal L emitted according to the on and off of the light-emitting unit 42, wave-shapes a waveform 61, which is an observation result of the received light level, into a binary rectangular waveform 62, generates an encoded signal based on the waveform 62, performs decoding processing based on the generated encoded signal to restore a reception signal corresponding to the transmission signal, and outputs the resulting reception signal.

Thus, a communication is achieved without using electromagnetic waves or the like as a medium, that is, there is no effect of electromagnetic waves on other communication devices and the human body, making it possible to achieve a safe communication even in places such as hospitals and on airplanes.

Furthermore, since the communication does not use electromagnetic waves or the like as a medium, there is no restriction on communication due to a lack of bandwidth.

In addition, since transmission and reception are performed using visible signals, the communication range can be intuitively recognized.

However, as illustrated in the example of the visible light wireless communication system 11 in FIG. 1, the amount of information that can be transferred by light emission or blinking of the light-emitting unit 42 is 1 bit. Therefore, there is no problem in transmitting and receiving small amounts of information such as ID information of equipment, but for example in order to transfer a large amount of information, it is necessary to use a high-speed, high-performance camera, which may increase costs.

Even if three-color LEDs are used to transmit three bits of information at a time, as in the technology of NPL 2, a typical camera can capture images in the RGB bands, but it is difficult to capture images in more than that number of bands.

Therefore, in the present disclosure, a light-emitting unit in which a plurality of light-emitting elements with different wavelength bands are combined and a snapshot-type spectroscopic camera that can capture spectral images in a plurality of wavelength bands in one shot are used to achieve a visible light communication using light in many wavelength bands, thereby increasing the amount of information transferred.

### 2. First Embodiment

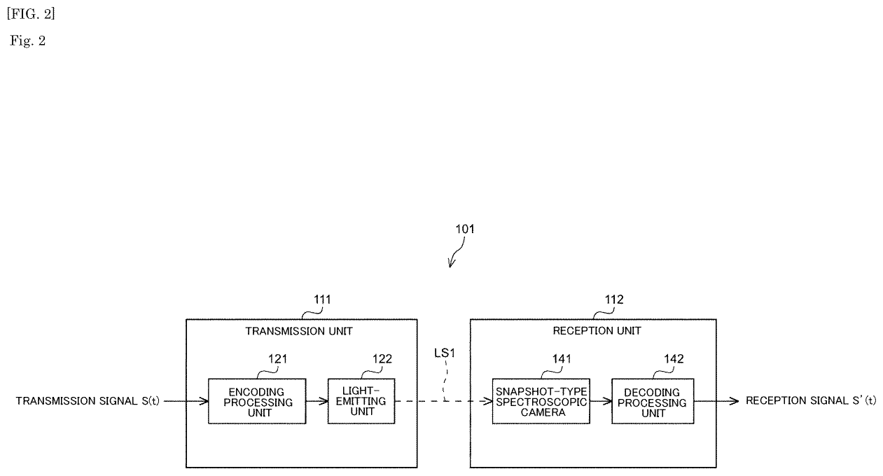

Next, a configuration example of a visible light communication system according to a first embodiment of the present disclosure will be described with reference to a block diagram of FIG. 2.

The visible light communication system 101 in FIG. 2 includes a transmission unit 111 and a reception unit 112.

In response to receiving the input of a time-series transmission signal S(t), the transmission unit 111 converts the received transmission signal S(t) into an encoded signal made up of a predetermined-length binary bit string, and based on the encoded signal, emits or extinguishes visible light in multiple wavelength bands to transmit the encoded signal as a visible light signal LS1. In the present embodiment, the predetermined-length binary bit string is 8 bits, but the number of bits is not limited to this.

The reception unit 112 captures as a spectral image the visible light signal LS1 in a plurality of wavelength bands, emitted by the transmission unit 111.

Then, the reception unit 112 generates an encoded signal made up of a binary bit string based on an intensity distribution for each wavelength band (optical spectral intensity distribution) obtained from the captured spectral image, decodes the generated encoded signal to restore a reception signal S′(t) corresponding to the transmission signal S(t), and outputs the reception signal S′(t).

More specifically, the transmission unit 111 includes an encoding processing unit 121 and a light-emitting unit 122.

In response to receiving the input of the transmission signal S(t), the encoding processing unit 121 performs encoding processing to convert the transmission signal S(t) into an encoded signal made up of a binary bit string, and outputs the encoded signal to the light-emitting unit 122.

The light-emitting unit 122 has a configuration having a plurality of light-emitting elements that emit light in a plurality of wavelength bands, and controls the on and off of the plurality of light-emitting elements based on the encoded signal made up of the binary bit string, supplied from the encoding processing unit 121. Thus, the light-emitting unit 122, which includes a plurality of light-emitting elements, emits light having intensity distributions for the respective wavelength bands corresponding to the encoded signal made up of a binary bit string, thereby transmitting the encoded signal as the visible light signal LS1.

### Configuration Example of Light-Emitting Unit

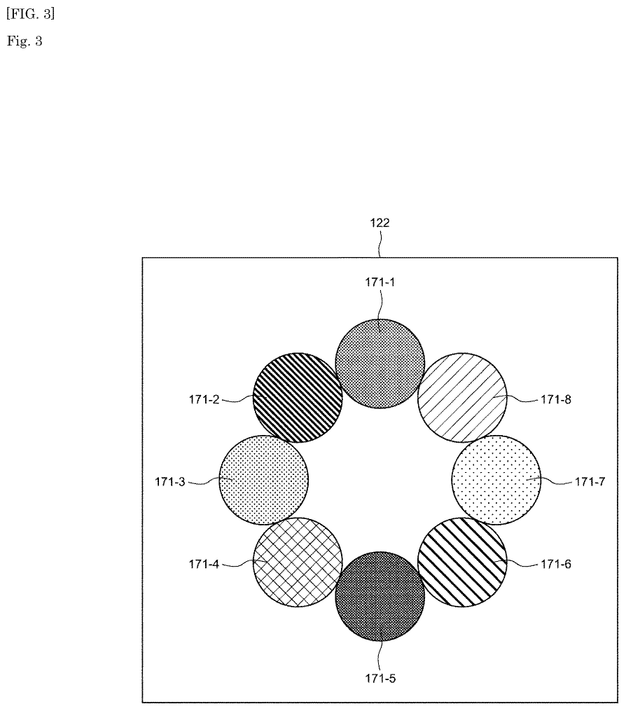

A configuration example of the light-emitting unit 122 will now be described with reference to FIG. 3. For example, as illustrated in FIG. 3, the light-emitting unit 122 includes light-emitting elements 171-1 to 171-8 that emit light in different wavelength bands. Hereinafter, unless it is necessary to specifically distinguish between the light-emitting elements 171-1 to 171-8, they will be simply referred to as the light-emitting element 171, and other components will also be referred to in the same way.

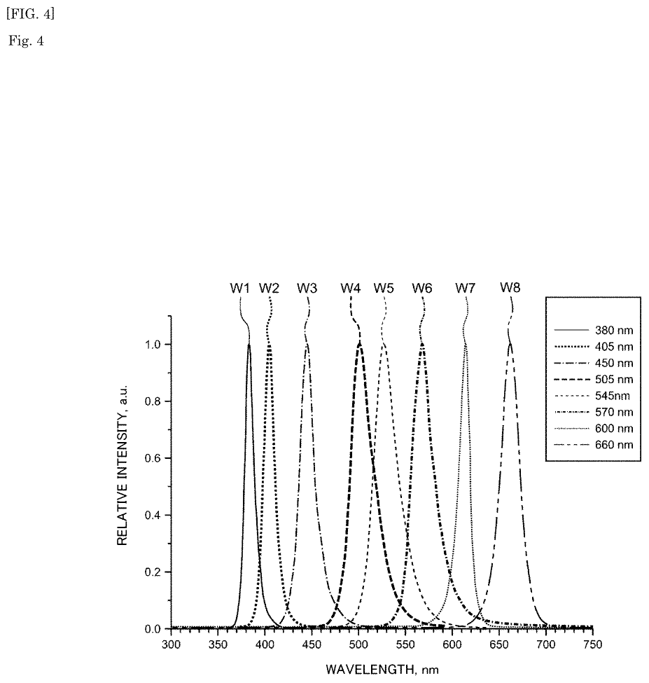

The light-emitting elements 171-1 to 171-8 emit light in different wavelength bands as indicated by waveforms W1 to W8, respectively, in FIG. 4. More specifically, the light-emitting elements 171-1 to 171-8 each include a light source such as an LED or a light bulb, and each have a configuration in which a bandpass filter that transmits light in the corresponding one of different wavelength bands as indicated by the waveforms W1 to W8 in FIG. 4 is placed in front of the light source.

With this configuration, the light-emitting elements 171-1 to 171-8 emit light in different wavelength bands as indicated by the waveforms W1 to W8 through a process that only light in the wavelength band corresponding to the bandpass filter placed in front of each light-emitting element transmits as the corresponding light source emits light.

More specifically, for example, as illustrated in FIGS. 3 and 4, the light-emitting element 171-1 in FIG. 3 emits light in a first band of wavelengths, which has a peak intensity at a wavelength of 380 nm, as indicated by the waveform W1 in FIG. 4.

The light-emitting element 171-2 in FIG. 3 emits light in a second band of wavelengths, which has a peak intensity at a wavelength of 405 nm, as indicated by the waveform W2 in FIG. 4.

The light-emitting element 171-3 in FIG. 3 emits light in a third band of wavelengths, which has a peak intensity at a wavelength of 450 nm, as indicated by the waveform W3 in FIG. 4.

The light-emitting element 171-4 in FIG. 3 emits light in a fourth band of wavelengths, which has a peak intensity at a wavelength of 505 nm, as indicated by the waveform W4 in FIG. 4.

The light-emitting element 171-5 in FIG. 3 emits light in a fifth band of wavelengths, which has a peak intensity at a wavelength of 545 nm, as indicated by the waveform W5 in FIG. 4.

The light-emitting element 171-6 in FIG. 3 emits light in a sixth band of wavelengths, which has a peak intensity at a wavelength of 570 nm, as indicated by the waveform W6 in FIG. 4.

The light-emitting element 171-7 in FIG. 3 emits light in a seventh band of wavelengths, which has a peak intensity at a wavelength of 600 nm, as indicated by the waveform W7 in FIG. 4.

The light-emitting element 171-8 in FIG. 3 emits light in an eight band of wavelengths, which has a peak intensity at a wavelength of 660 nm, as indicated by the waveform W8 in FIG. 4.

The light-emitting unit 122 controls the on and off of the light-emitting elements 171-1 to 171-8 based on an encoded signal made up of an 8-bit binary bit string, supplied from the encoding processing unit 121, to emit to the reception unit 112 light with intensity distributions (spectral intensity distributions) of the first to eighth bands, respectively, which corresponds to the encoded signal made up of the binary bit string described above.

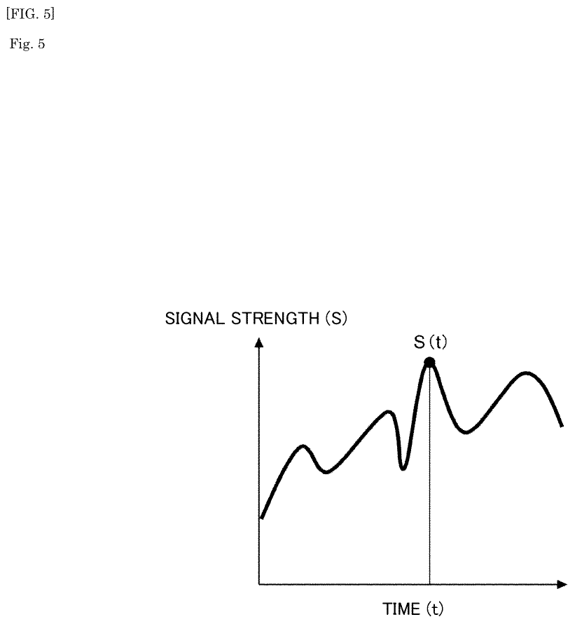

More specifically, for example, as indicated by the waveform with a signal strength S in FIG. 5, when a transmission signal is transmitted with, for example, a signal strength S(t) at time t among signals whose strength changes in accordance with changes in time series represented by time t, the encoding processing unit 121 performs encoding processing to convert the transmission signal with the signal strength S(t) into an encoded signal made up of an 8-bit binary bit string, and outputs the encoded signal to the light-emitting unit 122.

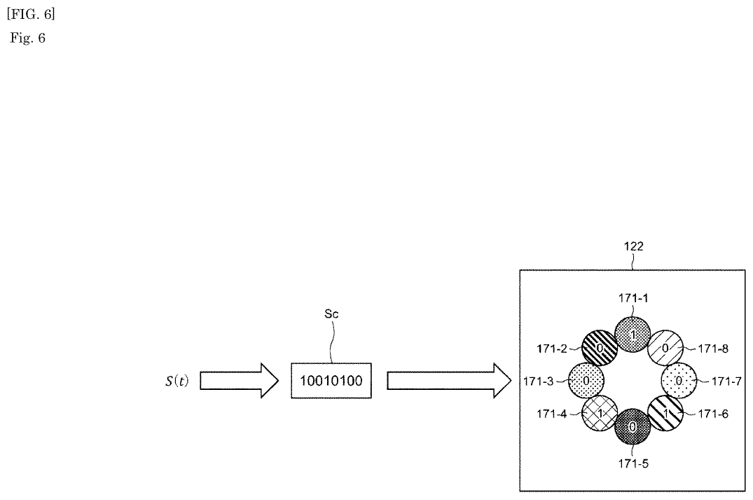

For example, now consider a case where the encoding processing unit 121 performs encoding processing to convert the transmission signal with the signal strength S(t) at time t into an encoded signal Sc made up of a binary bit string represented as “10010100”, as illustrated in FIG. 6.

In this case, the light-emitting unit 122 controls the light-emitting elements 171-1 to 171-8 to be turned on or off in accordance with the value at each bit position of the 8-bit encoded signal Sc.

More specifically, for the first bit of “1”, the light-emitting unit 122 controls the light-emitting element 171-1 to be turned on, as illustrated on the right side in FIG. 6.

For the second bit and the third bit of “0”, the light-emitting unit 122 controls the light-emitting elements 171-2 and 171-3 to be turned off, as illustrated on the right side in FIG. 6.

For the fourth bit of “1”, the light-emitting unit 122 controls the light-emitting element 171-4 to be turned on, as illustrated on the right side in FIG. 6.

For the fifth bit of “0”, the light-emitting unit 122 controls the light-emitting element 171-5 to be turned off, as illustrated on the right side in FIG. 6.

For the sixth bit of “1”, the light-emitting unit 122 controls the light-emitting element 171-6 to be turned on, as illustrated on the right side in FIG. 6.

For the seventh bit and the eighth bit of “0”, the light-emitting unit 122 controls the light-emitting elements 171-7 and 171-8 to be turned off, as illustrated on the right side in FIG. 6.

In other words, the light-emitting unit 122 controls the on and off of the light-emitting elements 171-1 to 171-8 based on the encoded signal made up of the binary bit string, which is a result of encoding the transmission signal S(t), to emit light with band intensity distributions (spectral intensity distributions), which corresponds to the encoded signal made up of the binary bit string.

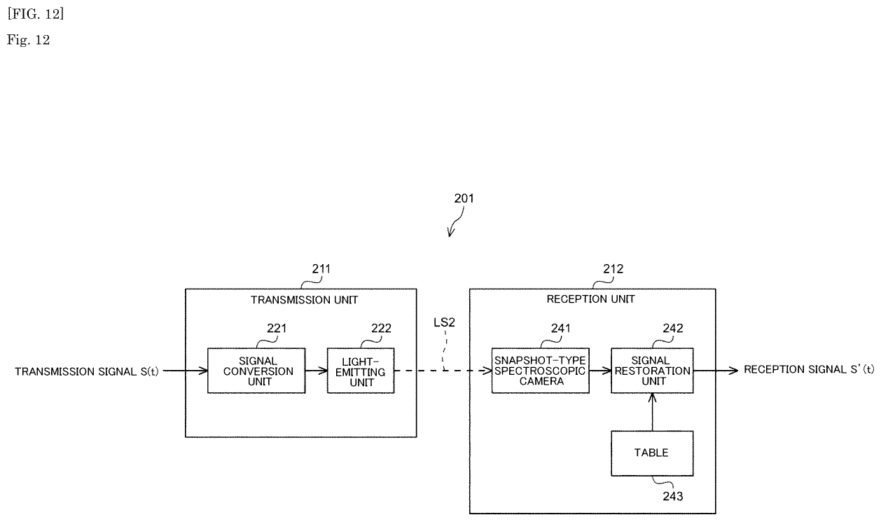

The layout of the light-emitting elements 171-1 to 171-8 in the light-emitting unit 122 does not necessarily have to be a circular layout as illustrated in FIG. 12, and the layout is not limited to that of FIG. 12 as long as they are arranged on the light-emitting surface.

Now, the description of the visible light communication system 101 is referred back to.

The reception unit 112 includes a snapshot-type spectroscopic camera 141 and a decoding processing unit 142.

The snapshot-type spectroscopic camera 141 captures (detects) a spectral image having a spectral intensity distribution, which is an intensity distribution for each wavelength band, at each pixel position in the imaging plane, and outputs the resulting image capture results (detection results) to the decoding processing unit 142 as a three-dimensional spectral image data set (data cube).

The snapshot-type spectroscopic camera 141 has, for example, a configuration in which a plurality of different bandpass filters respectively corresponding to the wavelength characteristics of the light-emitting elements 171-1 to 171-8 of the light-emitting unit 122 are stuck to the surface of an image sensor such as a complementary metal oxide semiconductor (CMOS) sensor, and/or a configuration in which a diffraction element is introduced into a lens.

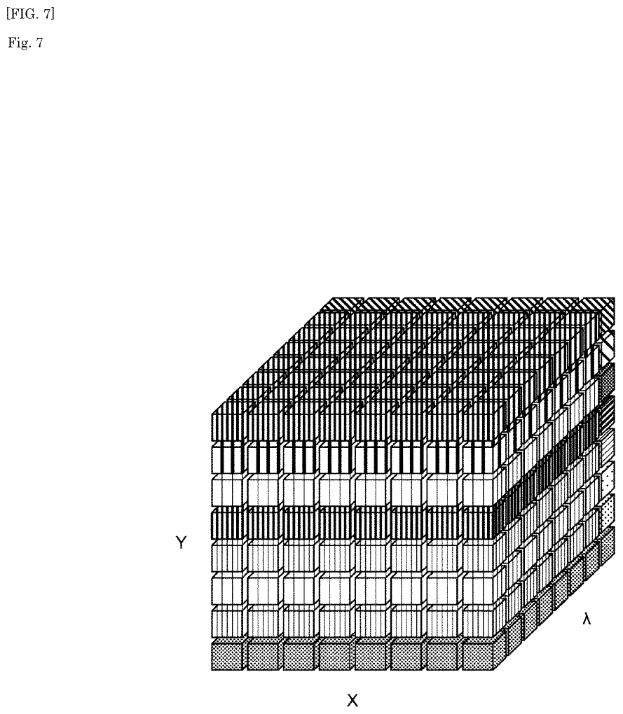

The three-dimensional spectral image data set (data cube) is, for example, a data set as illustrated in FIG. 7, and also a data set in which data indicating a band intensity distribution (spectral intensity distribution) for each wavelength λ at each coordinate position (X, Y) on a two-dimensional plane corresponding to the imaging surface, expressed by the XY axes, is expressed in three dimensions of X, Y, and λ. In other words, each of the rectangular objects in FIG. 7 represents a received light intensity of a wavelength λ at a position (X, Y).

For details about the snapshot-type spectroscopic camera, see, for example, International Publication No. WO 2013/064512.

The decoding processing unit 142 encodes the spectral intensity distribution at a pixel position where the light-emitting unit 122 is imaged, in the three-dimensional spectral image data set (data cube), into an encoded signal made up of a binary bit string, and further performs decoding processing on the encoded signal made up of the binary bit string to restore and output the reception signal S′(t) corresponding to the transmission signal S(t).

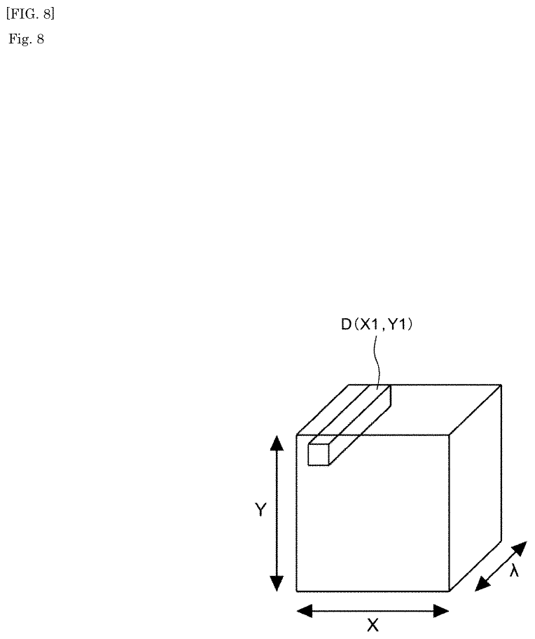

For example, as illustrated in FIG. 8, when the imaged position of the light-emitting unit 122 is at a position (X1, Y1) within the imaging plane of the snapshot-type spectroscopic camera 141, the decoding processing unit 142 reads a band intensity distribution (spectral intensity distribution) D(X1, Y1) at the position (X1, Y1), and converts it into an encoded signal made up of a binary bit string.

Since the positional relationship between the snapshot-type spectroscopic camera 141 and the light-emitting unit 122 is known information, the imaged position of the light-emitting unit 122 within the imaging plane of the snapshot-type spectroscopic camera 141 may be set as known information.

More specifically, the decoding processing unit 142 converts the band intensity distribution (spectral intensity distribution) D(X1, Y1) into an encoded signal made up of a binary bit string in a manner that compares the peak intensity of each wavelength band with a threshold value Lth, and when the peak intensity exceeds the threshold value Lth, converts the corresponding bit of the wavelength band into 1, and when the peak intensity does not exceed the threshold value Lth, converts the corresponding bit of the wavelength band into 0.

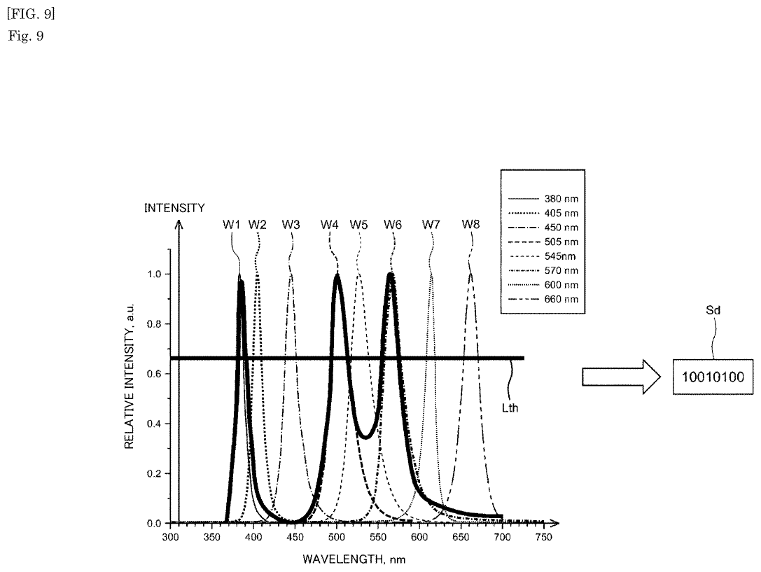

For example, when the band intensity distribution (spectral intensity distribution) D(X1, Y1) is a waveform indicated by a thick line in a waveform diagram on the left side of FIG. 9, the peak intensity of each of the first band, the fourth band, and the sixth band respectively corresponding to the waveforms W1, W4, and W6 is higher than the threshold Lth, and thus the decoding processing unit 142 converts the first bit, the fourth bit, and the sixth bit into 1, and converts the other bits into 0.

As a result, in the case of FIG. 9, the decoding processing unit 142 converts the band intensity distribution (spectral intensity distribution) D(X1, Y1) into an encoded signal Sd made up of a binary bit string of “10010100”.

The decoding processing unit 142 further decodes this encoded signal Sd made up of the binary bit string to restore a reception signal S′(t) corresponding to the transmission signal S(t).

With the above configuration, the light-emitting unit 122 controls the on and off of the light-emitting elements 171-1 to 171-8 that emit light in eight different wavelength bands, making it possible to transmit 8 bits of information in one light emission processing.

An example has been described in which eight light-emitting elements as the light-emitting elements 171-1 to 171-8 are provided in the light-emitting unit 122 of the transmission unit 111 in FIG. 2. However, a configuration in which a different number of light-emitting elements 171 from eight are provided may be used. In this case, it is possible to transmit information with a number of bits corresponding to the number of light-emitting elements 171 in one light emission. However, the number of light-emitting elements 171 provided in the light-emitting unit 122 needs to correspond to the wavelength resolution of the snapshot-type spectroscopic camera 141.

### Transmission Processing by Transmission Unit in FIG. 2

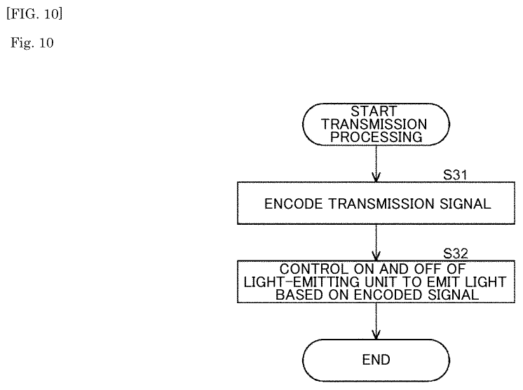

Next, transmission processing performed by the transmission unit 111 in FIG. 2 will be described with reference to a flowchart in FIG. 10.

In step S31, the encoding processing unit 121 encodes the input transmission signal S(t) into an encoded signal made up of an 8-bit binary bit string, and outputs the encoded signal to the light-emitting unit 122.

In step S32, the light-emitting unit 122 controls the light-emitting elements 171-1 to 171-8 to be turned on and off based on the encoded signal made up of the 8-bit binary bit string.

The above processing makes it possible to transmit an encoded signal corresponding to an 8-bit binary bit string in one light emission processing.

### Reception Processing by Reception Unit in FIG. 2

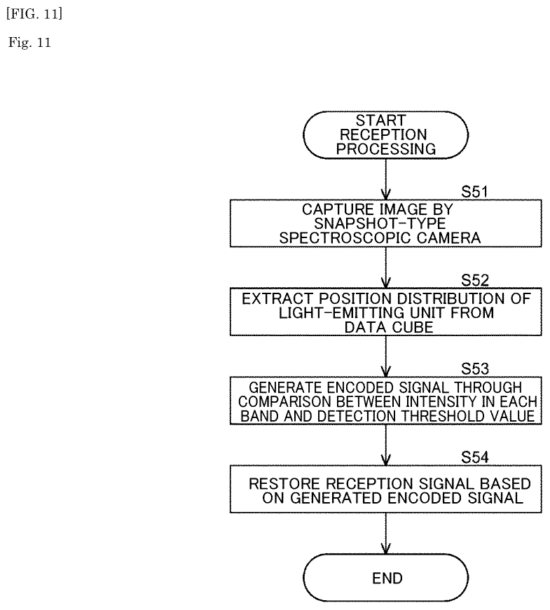

Next, reception processing performed by the reception unit 112 in FIG. 2 will be described with reference to a flowchart in FIG. 11.

In step S51, when the light-emitting unit 122 of the transmission unit 111 is present within the field of view and light emission is controlled by the transmission processing described above, the snapshot-type spectroscopic camera 141 captures a spectral image and outputs the spectral image to the decoding processing unit 142 as a three-dimensional spectral image data set (data cube).

In step S52, the decoding processing unit 142 extracts from the three-dimensional spectral image data set (data cube) the band intensity distribution (spectral intensity distribution) at the position where the light-emitting unit 122 is present.

In step S53, the decoding processing unit 142 generates (reproduces) an encoded signal made up of an 8-bit binary bit string in a manner that compares the peak signal strength of each of the first to eighth bands respectively corresponding to the waveforms W1 to W8 described with reference to FIG. 4 from the extracted band intensity distribution (spectral intensity distribution) with the detection threshold Lth, and in decoding, assigns 1 to the corresponding bit when the peak signal strength is higher than the detection threshold Lth; otherwise assigns 0.

In step S54, the decoding processing unit 142 restores and outputs a reception signal S′(t) corresponding to the transmission signal S(t) based on the generated encoded signal made up of the 8-bit binary bit string.

The above processing makes it possible to receive an 8-bit encoded signal in the receiving processing for one light emission of the light-emitting unit 122 of the transmission unit 111.

As described above, according to the visible light communication system of the present disclosure, the transmission unit controls the on and off of the plurality of light-emitting elements 171 that emit light in different wavelength bands, based on an encoded signal made up of a plurality of bits in which the transmission signal is encoded.

In addition, the reception unit causes the snapshot-type spectroscopic camera 141 to capture the light emitted by the plurality of light-emitting elements 171, reproduces the encoded signal based on a spectral intensity distribution that is the result of image capture, and decodes the encoded signal corresponding to the transmission signal to restore the transmission signal.

This makes it possible to transmit and receive a plurality of bits of information corresponding to the number of light-emitting elements 171 in one light emission.

As a result, it is possible to cause an increase in the amount of information to be transmitted and received at high speed in the visible light communication system.

### 3. Second Embodiment

An example has been described above in which a transmission signal S(t) at time t is encoded into an encoded signal made up of a binary bit string, and information using a number of bits corresponding to the number of light-emitting elements 171 is transmitted and received in one light emission processing by turning on and off the plurality of light-emitting elements 171 with different wavelength bands.

However, by controlling the light emission intensity of each of the plurality of light-emitting elements with different wavelength bands, a plurality of continuous transmission signals for a predetermined period may be transmitted and received in response to one light emission.

FIG. 12 illustrates an example configuration of a visible light communication system 201 that can transmit and receive a plurality of continuous transmission signals for a predetermined period in response to one light emission by controlling the light emission intensity of each of the plurality of light-emitting elements with different wavelength bands.

The visible light communication system 201 includes a transmission unit 211 and a reception unit 212. The transmission unit 211 and the reception unit 212 are configured to correspond to the transmission unit 111 and the reception unit 112 in FIG. 2, and the transmission unit 211 transmits a transmission signal S(t) by emitting light, and the reception unit 212 receives the light to restore and output a reception signal S′(t) corresponding to the transmission signal S(t).

The transmission unit 211 includes a signal conversion unit 221 and a light-emitting unit 222.

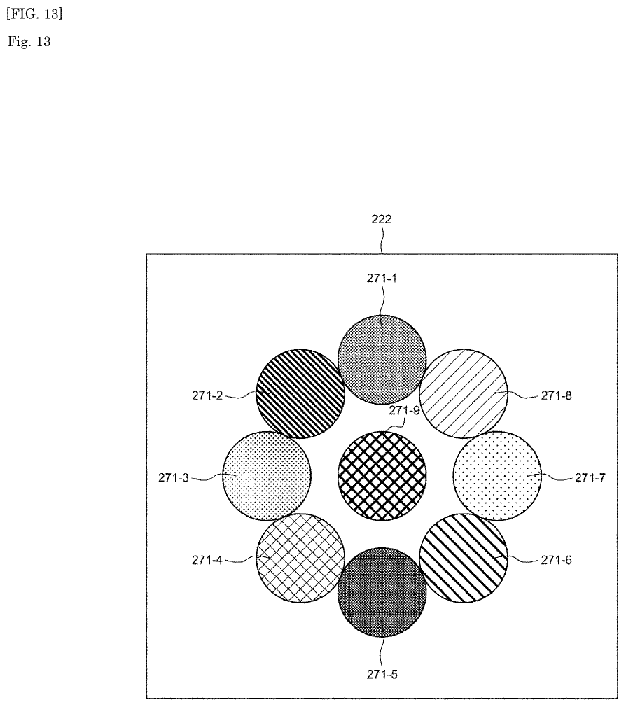

For example, the signal conversion unit 221 buffers eight continuous transmission signals S(t1), . . . , S(t8) for a predetermined period from time t1 to t8, then converts the transmission signals into voltage signals for controlling the respective light emission intensities of light-emitting elements 271-1 to 271-8 (FIG. 13) that are provided in the light-emitting unit 222 to emit light with eight different wavelength bands, and outputs the voltage signals to the light-emitting unit 222.

The light-emitting unit 222 includes, for example, nine light-emitting elements 271-1 to 271-9 as illustrated in FIG. 13.

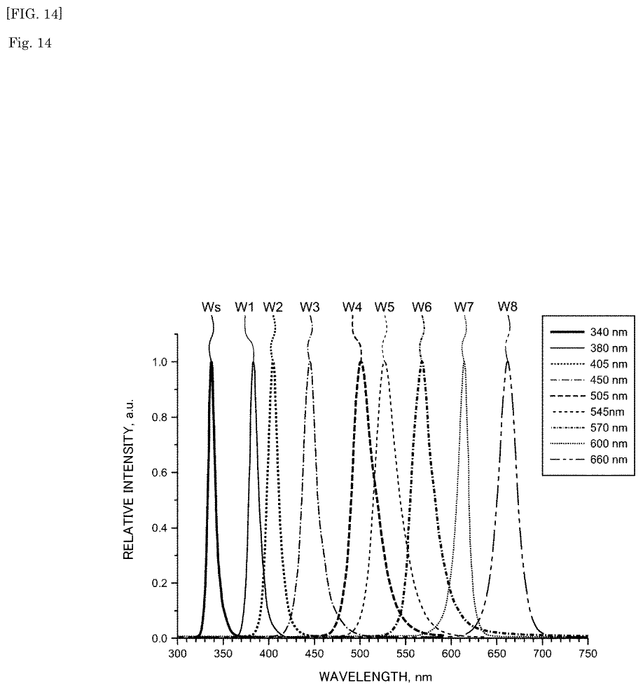

The light-emitting elements 271-1 to 271-8 have basically the same configuration as the light-emitting elements 171-1 to 171-8, and emit light respectively in first to eighth wavelength bands indicated by waveforms W1 to W8 in FIG. 14. The waveforms W1 to W8 in FIG. 14 are the same waveforms as the waveforms W1 to W8 in FIG. 4.

The light-emitting element 271-9 emits light in a wavelength band different from the light-emitting elements 271-1 to 271-8.

The wavelength band of light emitted by the light-emitting element 271-9 is, for example, light in a reference wavelength band (reference band) with a peak intensity at a wavelength of 340 nm, as indicated by a waveform Ws in FIG. 14.

The wavelength band of the light emitted by the light-emitting element 271-9 may be a wavelength band other than this waveform Ws as long as it is different from the wavelength bands of the light-emitting elements 271-1 to 271-8.

That is, the light-emitting unit 222 controls the light emission intensities of the light-emitting elements 271-1 to 271-8 to emit light based on the eight voltage signals supplied from the signal conversion unit 221.

The light-emitting unit 222 causes the light-emitting element 271-9 to emit light at a predetermined reference light emission intensity that is independent of the transmission signal S(t).

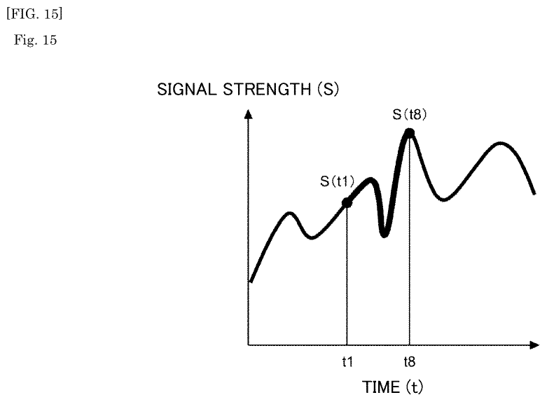

More specifically, for example, now consider a case where among the signal strengths S(t) in FIG. 15, the signal strengths S(t1), S(t2), S(t3), . . . , S(t8) at times t1, t2, t3, . . . , t8 are transmitted with the transmission signal S.

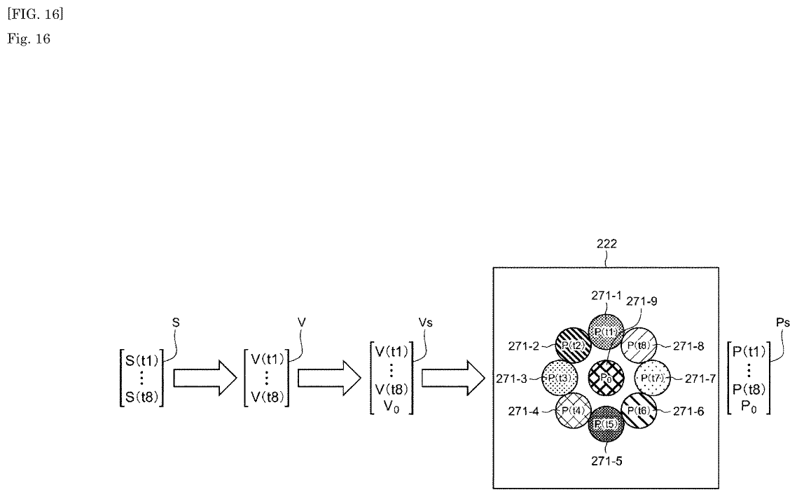

In this case, as illustrated in FIG. 16, the signal conversion unit 221 converts the transmission signal S with signal strengths S(t1), S(t2), S(t3), . . . , S(t8) into a voltage signal V with applied voltages V(t1), V(t2), V(t3), . . . , V(t8) for controlling the light emission intensities of their respective light-emitting elements 271-1 to 271-8 of the light-emitting unit 222.

In addition, the signal conversion unit 221 generates a voltage signal Vs in which a reference voltage V0 for causing the light-emitting element 271-9 of the light-emitting unit 222 to emit light at the predetermined reference light emission intensity is added, and outputs the voltage signal Vs to the light-emitting unit 222.

In this case, the light-emitting unit 222 causes the light-emitting elements 271-1 to 271-9 to emit light with light emission intensities based on the voltage signal Vs supplied from the signal conversion unit 221.

Specifically, the light-emitting unit 222 applies the applied voltage V(t1) in the voltage signal Vs to the light-emitting element 271-1, so that the light-emitting element 271-1 emits light with a light emission intensity P(t1).

Similarly, the light-emitting unit 222 applies the voltages V(t2) to V(t8) in the voltage signal Vs to the light-emitting elements 271-2 to 271-8, so that the light-emitting elements 271-2 to 271-8 emit light with light emission intensities P(t2) to P(t8), respectively.

The light-emitting unit 222 also applies the reference voltage V0 in the voltage signal Vs to the light-emitting element 271-9, so that the light-emitting element 271-9 emits light with a reference light emission intensity P0 (hereinafter also referred to as the reference intensity P0).

Specifically, in the example of FIG. 16, the light-emitting elements 271-1 to 271-9 emit light with the light emission intensities P(t1) to P(t8) and the reference intensity P0, respectively, so that the light-emitting unit 222 as a whole emits light with a band intensity distribution (spectral intensity distribution) Ps in which the first to eighth bands and the reference band respectively corresponding to the light-emitting elements 271-1 to 271-9 have the light emission intensities P(t1) to P(t8) and the reference intensity P0, and transmits that light as a visible light signal LS2.

Now, the description of the visible light communication system 201 is referred back to.

The reception unit 212 includes a snapshot-type spectroscopic camera 241, a signal restoration unit 242, and a table 243.

The snapshot-type spectroscopic camera 241 has the same configuration as the snapshot-type spectroscopic camera 141 in FIG. 2, and captures (detects) the visible light signal LS2 as a spectral image, detects a spectral result at each pixel position within the imaging plane as a spectral intensity distribution, which is an intensity distribution for each wavelength band, and outputs the resulting spectral intensity distributions to the signal restoration unit 242 as a three-dimensional spectral image data set (data cube).

The signal restoration unit 242 restores a reception signal S′(t) corresponding to the transmission signal S(t) at a predetermined time based on the spectral intensity distribution of the first to eighth bands in the spectral intensity distribution at the pixel position where the light-emitting unit 222 is imaged, from the three-dimensional spectral image data set (data cube) supplied from the snapshot-type spectroscopic camera 241.

Meanwhile, the signal restoration unit 242 corrects based on the intensity of the reference band the attenuation of light emission intensity that occurs depending on distance in the first to eighth bands.

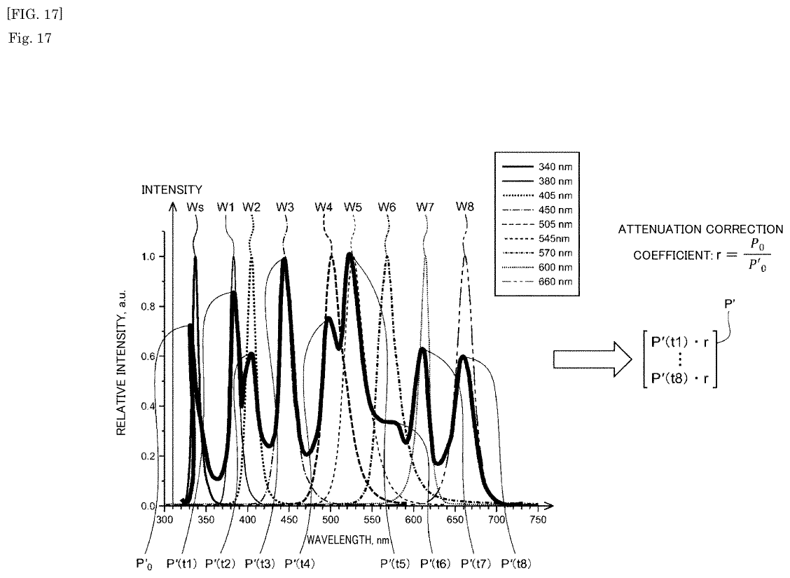

Specifically, for example, consider a case where the spectral intensity distribution at the pixel position where the light-emitting unit 222 is imaged in the three-dimensional spectral image data set (data cube) is a spectral intensity distribution indicated by a thick line on the left side in FIG. 17.

Also, in the spectral intensity distribution of FIG. 17, given that the peak intensities of the reference band and the first to eighth bands are light emission intensities P′0 and P′(t1) to P′(t8), respectively.

In the light-emitting unit 222 of the transmission unit 211, the light-emitting elements 271-1 to 271-8 emit light with intensities corresponding to the transmission signals S(t1) to S(t8). Accordingly, the reception unit 212 needs to restore reception signals S′(t1) to S′(t8) corresponding to the transmission signals S(t1) to S(t8), taking into account the attenuation of intensity depending on distance.

Here, the light-emitting element 271-9 always emits light with the reference intensity P0, independent of the transmission signal S(t), and the signal restoration unit 242 stores this reference intensity P0 in advance.

Therefore, the signal restoration unit 242 divides this reference intensity P0 by a light emission intensity P′0 of the reference band in the spectral intensity distribution actually detected by the snapshot-type spectroscopic camera 241 to calculate an attenuation correction coefficient r (=P0/P′0).

Then, the signal restoration unit 242 multiplies each of the light emission intensities P′(t1) to P′(t8), which are the peaks of the first to eighth bands in the spectral intensity distribution, by the attenuation correction coefficient r, to correct the light emission intensity that is the peak of each band in the spectral intensity distribution, thereby generating a light emission intensity P′.

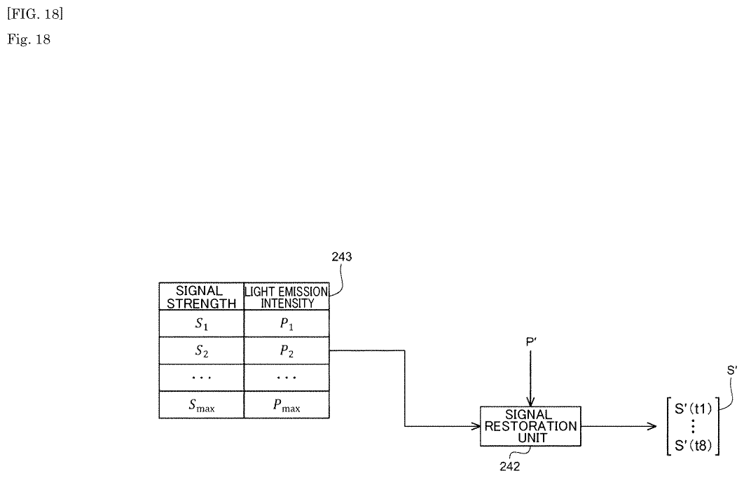

As illustrated in FIG. 18, the signal restoration unit 242 also accesses the table 243 that is a correspondence table between light emission intensity and signal strength, to read the signal strength corresponding to the light emission intensity of each band in the light emission signal P′ in which the light attenuation occurring depending on distance has been corrected, and thus restores the reception signal S′(t) corresponding to the transmission signal S(t).

In the table 243 of FIG. 18, signal strengths S1, S2, . . . , Smax are listed from the top on the left side, and corresponding light emission intensities P1, P2, . . . , Pmax are listed on the right side.

Accordingly, in this case, the signal restoration unit 242 restores based on the information in the table 243 the reception signal S′ corresponding to the transmission signal S, with signal strengths S′(t1) to S′(t8) respectively corresponding to the light emission intensities P′ (t1)·r to P′(t8)·r in which the intensities have been corrected by the attenuation correction coefficient r.

With the above configuration, the light-emitting unit 222 controls the light emission intensities of eight light-emitting elements 271, which are the light-emitting elements 271-1 to 271-8, making it possible to transmit eight pieces of information in one light emission processing.

An example has been described in which eight light-emitting elements 271-1 to 271-8 are provided in the light-emitting unit 222 of the transmission unit 211 in FIG. 12. However, a configuration in which a different number of light-emitting elements 271 from eight are provided may be used, which makes it possible to transmit the number of pieces of information corresponding to the number of light-emitting elements 271 in one light emission. However, the number of light-emitting elements 271 provided in the light-emitting unit 222 needs to correspond to the wavelength resolution of the snapshot-type spectroscopic camera 241.

### Transmission Processing by Transmission Unit in FIG. 12

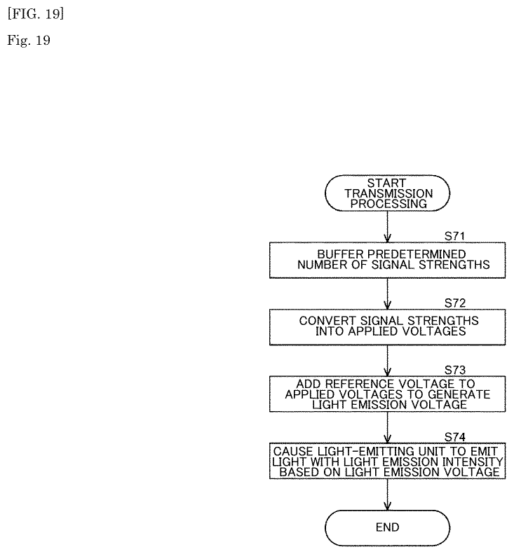

Next, transmission processing performed by the transmission unit 211 in FIG. 12 will be described with reference to a flowchart in FIG. 19.

In step S71, the signal conversion unit 221 buffers information on the signal strengths S(t1), S(t2), . . . , S(tn) included in the input transmission signal S(t) by the predetermined number n. In this example, the predetermined number n is 8, which corresponds to the light-emitting elements 271-1 to 271-8 in the light-emitting unit 222 in FIG. 13, and eight signal strengths S(t1), S(t2), . . . , S(t8) are buffered accordingly.

In step S72, in order to cause the light-emitting elements 271-1 to 271-8 of the light-emitting unit 222 to emit light at light emission intensities corresponding to the signal strengths S(t1), S(t2), . . . , S(t8), which are the eight buffered transmission signals S(t), respectively, the signal conversion unit 221 converts the signal strengths S(t1), S(t2), . . . , S(t8) into applied voltages V(t1), V(t2), . . . , V(t8), and generates a voltage signal V as a set of the applied voltages V(t1), V(t2), . . . , V(t8).

In step S73, the signal conversion unit 221 generates a voltage signal Vs by adding to the voltage signal V the reference voltage V0 for the light-emitting element 271-9 of the light-emitting unit 222 to emit light at the reference intensity P0, and supplies voltage signal Vs to the light-emitting unit 222.

In step S74, the light-emitting unit 222 applies a voltage based on the voltage signal Vs to the light-emitting elements 271-1 to 271-9 to emit light at their respective light emission intensities.

The above processing makes it possible to emit light in the first to eighth bands and the reference band by using the applied voltages corresponding to the eight transmission signals S that are continuous in time series and the reference voltage.

As a result, it is possible to transmit eight pieces of information that are continuous in time series in one light emission processing, and to emit light with the reference intensity for determining the attenuation correction coefficient r.

### Reception Processing by Reception Unit in FIG. 12

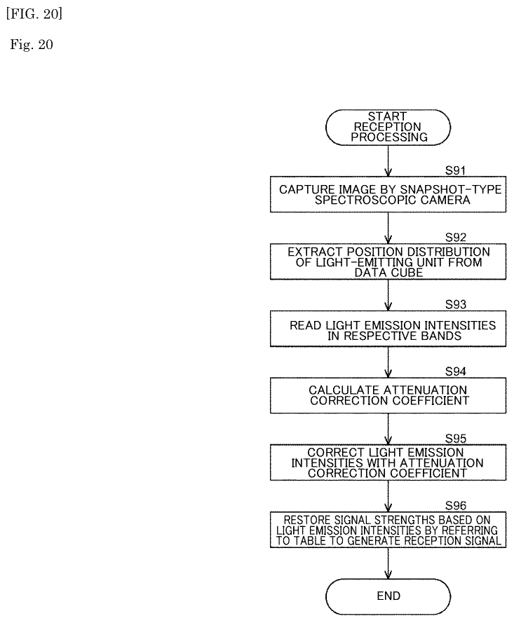

Next, reception processing performed by the reception unit 212 in FIG. 12 will be described with reference to a flowchart in FIG. 20.

In step S91, when the light-emitting unit 222 of the transmission unit 211 is present within the field of view and light emission is controlled by the transmission processing described above, the snapshot-type spectroscopic camera 241 captures a spectral image and outputs the spectral image to the signal restoration unit 242 as a three-dimensional spectral image data set (data cube).

In step S92, the signal restoration unit 242 extracts from the three-dimensional spectral image data set (data cube) the band intensity distribution (spectral intensity distribution) at the position where the light-emitting unit 222 is present.

In step S93, the signal restoration unit 242 reads the peak light intensities of the reference band and the first to eighth bands, which correspond to the waveforms W0 to W8 described with reference to FIG. 17, from the band intensity distribution (spectral intensity distribution).

In step S94, the signal restoration unit 242 calculates the attenuation correction coefficient r based on the light emission intensity of the reference band.

In step S95, the signal restoration unit 242 corrects the light emission intensities based on the attenuation correction coefficient r to reproduce the light emission intensities of the light-emitting unit 222.

In step S96, the signal restoration unit 242 accesses the table 243 to read the signal strengths corresponding to the corrected light emission intensities of the light-emitting unit 222, and thus restores and outputs the reception signal S′(t) corresponding to the transmission signal S.

The above processing makes it possible to receive eight types of information in the receiving processing for one light emission of the light-emitting unit 222 of the transmission unit 211.

This makes it possible to cause an increase in the amount of information to be transmitted in one light emission.

As described above, according to the visible light communication system of the present disclosure, the transmission unit causes the plurality of light-emitting elements 271 that emit light in different wavelength bands to emit light with the light emission intensities respectively corresponding to the plurality of signal strengths included in the transmission signal, as well as to emit light with the reference intensity.

In addition, the reception unit causes the snapshot-type spectroscopic camera 241 to capture the light emitted by the plurality of light-emitting elements 271, corrects the spectral intensity distribution that is the image capture result based on the light emission intensity of the wavelength band of light emitted with the reference intensity, and restores the plurality of transmission signals based on the light emission intensities of the corrected spectral intensity distribution.

This makes it possible to transmit and receive a plurality of pieces of information corresponding to the number of light-emitting elements 271 in one light emission.

As a result, it is possible to cause an increase in the amount of information to be transmitted and received in the visible light communication system and thus to implement large-capacity, high-speed communication.

As described above, according to the present disclosure, it is possible to cause the amount of information to be transferred in the visible light communication system to be increased easily at low cost.

### 4. Software-Performed Example

The above-described series of processing can also be performed by hardware or software. When the series of processing is performed by software, a program of the software is installed from a program storage medium to a computer embedded in dedicated hardware or, for example, a general-purpose computer capable of performing various functions by installing the various programs.

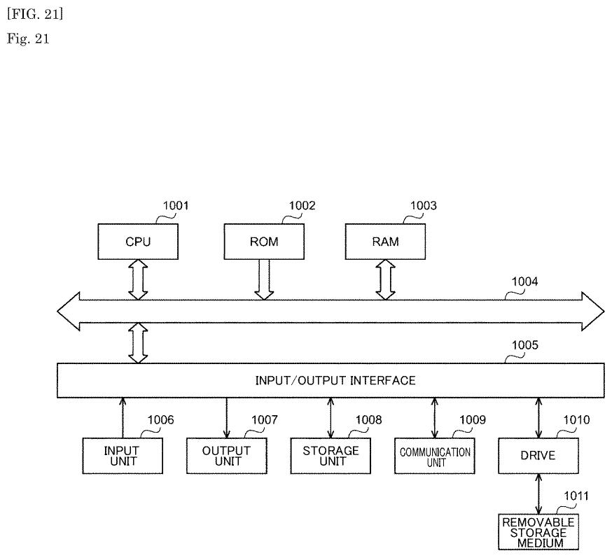

FIG. 21 illustrates a configuration example of a general-purpose computer. This personal computer includes a central processing unit (CPU) 1001 built therein. An input/output interface 1005 is connected to the CPU 1001 via a bus 1004. A read only memory (ROM) 1002 and a random access memory (RAM) 1003 are connected to the bus 1004.

An input unit 1006 including input devices such as a keyboard and a mouse for the user to input operation commands, an output unit 1007 that outputs a processing operation screen or an image of a processing result to a display device, a storage unit 1008 including, for example, a hard disk drive for storing programs and various types of data, and a communication unit 1009 that includes a local area network (LAN) adapter or the like and executes communication processing via a network represented by the Internet are connected to the input/output interface 1005. Further, a drive 1010 is connected that reads and writes data from and to a removable storage medium 1011 such as a magnetic disk (including a flexible disk), an optical disc (including a compact disc-read only memory (CD-ROM), a digital versatile disc (DVD)), a magneto-optical disc (including a mini disc (MD)), or a semiconductor memory.

The CPU 1001 executes various types of processing according to a program stored in the ROM 1002, or a program read from the removable storage medium 1011 such as a magnetic disk, an optical disk, a magneto-optical disk, or a semiconductor memory, installed in the storage unit 1008, and loaded into the RAM 1003 from the storage unit 1008. The RAM 1003 also appropriately stores data and the like necessary for the CPU 1001 to execute various types of processing.

In the computer configured as described above, the CPU 1001 loads, for example, a program stored in the storage unit 1008 into the RAM 1003 via the input/output interface 1005 and the bus 1004, and executes the program so that the above-described series of steps of processing are performed.

A program to be executed by the computer (the CPU 1001) can be provided by being recorded on the removable storage medium 1011 such as a package medium, for example. The program can also be provided via a wired or wireless transmission medium such as a local area network, the Internet, or digital satellite broadcasting.

In the computer, the program can be installed in the storage unit 1008 via the input/output interface 1005 by the removable storage medium 1011 being mounted in the drive 1010. The program can be received by the communication unit 1009 via a wired or wireless transmission medium to be installed in the storage unit 1008. In addition, this program may be installed in advance in the ROM 1002 or the storage unit 1008.

The program executed by a computer may be a program that performs processing chronologically in the order described in the present specification or may be a program that performs processing in parallel or at a necessary timing such as a called time.

The CPU 1001 in FIG. 21 implements the functions of at least one of the encoding processing unit 121 and the decoding processing unit 142 in FIG. 2; and the signal conversion unit 221 and the signal restoration unit 242 in FIG. 12.

In the present specification, the system means a set of a plurality of constituent elements (devices, modules (components), or the like) and all the constituent elements may or may not be included in a same casing. Accordingly, a plurality of devices accommodated in separate casings and connected via a network and one device in which a plurality of modules are accommodated in one casing both constitute systems.

Embodiments of the present disclosure are not limited to those described above and can be modified in various manners without departing from the gist of the present disclosure.

For example, the present disclosure may be configured through cloud computing in which a plurality of devices share and cooperatively process one function over a network.

In addition, each step described in the above flowchart can be executed by one device or executed in a shared manner by a plurality of devices.

Further, in a case where a plurality of kinds of processing are included in a single step, the plurality of kinds of processing included in the single step may be executed by one device or by a plurality of devices in a shared manner.

The present disclosure can also be configured as follows.
<1> A communication system including a transmission unit and a reception unit,
wherein
the transmission unit includes:
a light-emitting unit that has a plurality of light-emitting elements that emit light in different wavelength bands, the light-emitting unit controlling light emission of the plurality of light-emitting elements; and
a signal generation unit that generates as a control signal a signal to control the light emission of the plurality of light-emitting elements based on a transmission signal, and supplies the control signal to the light-emitting unit, and the reception unit includes:
a snapshot-type spectroscopic camera that detects an optical spectrum of light emitted by the light-emitting unit; and
a restoration unit that restores the transmission signal based on light emission intensities in wavelength bands respectively corresponding to the plurality of light-emitting elements in the optical spectrum detected by the snapshot-type spectroscopic camera.
<2> The communication system according to <1>, wherein the signal generation unit encodes a signal strength of the transmission signal into an encoded signal made up of a binary bit string with a predetermined number of bits, and supplies the encoded signal to the light-emitting unit as the control signal,
the light-emitting unit controls the light-emitting elements to be turned on or off based on the control signal that is the encoded signal, and
the restoration unit converts the light emission intensities in the wavelength bands respectively corresponding to the plurality of light-emitting elements in the optical spectrum into a binary bit string corresponding to the encoded signal through comparison with a predetermined threshold value, and restores the signal strength of the transmission signal based on the binary bit string.
<3> The communication system according to <2>, wherein the transmission signal has the signal strength at a predetermined time among signals in which the signal strength changes continuously over time.
<4> The communication system according to <2>, wherein the predetermined number of bits corresponds to the number of the plurality of light-emitting elements.
<5> The communication system according to <1>, wherein
the signal generation unit converts a signal strength of the transmission signal into applied voltage values for causing the plurality of light-emitting elements to emit light with corresponding light emission intensities, and supplies the applied voltage values to the light-emitting unit as the control signal,
the light-emitting unit controls the light emission intensities of the plurality of light-emitting elements based on the control signal including the applied voltage values, and
the restoration unit restores the signal strength of the transmission signal based on light emission intensities in the plurality of wavelength bands respectively corresponding to the plurality of light-emitting elements in the optical spectrum.
<6> The communication system according to <5>, wherein
the light-emitting unit further includes another light-emitting element that always emits light with a predetermined light emission intensity in a wavelength band different from the plurality of light-emitting elements, and
the restoration unit corrects, based on the light emission intensity in the wavelength band of the other light-emitting element, an attenuation occurring in the light emission intensities in the plurality of wavelength bands respectively corresponding to the plurality of light-emitting elements in the optical spectrum, and restores the signal strength of the transmission signal based on the corrected light emission intensities in the plurality of wavelength bands.
<7> The communication system according to <6>, wherein the restoration unit calculates a correction coefficient based on the light emission intensity in the wavelength band of the other light-emitting element in the optical spectrum, and corrects the light emission intensities in the plurality of wavelength bands in the optical spectrum by multiplication by the calculated correction coefficient, and restores the signal strength of the transmission signal based on the corrected light emission intensities in the plurality of wavelength bands.
<8> The communication system according to <7>, wherein the restoration unit calculates the correction coefficient by dividing the predetermined light emission intensity by the light emission intensity in the wavelength band of the other light-emitting element in the optical spectrum.
<9> The communication system according to <6>, wherein
the signal generation unit supplies to the light-emitting unit the control signal including an applied voltage value for causing the other light-emitting element to emit light with the predetermined light emission intensity, and
the light-emitting unit controls the light emission intensities of the plurality of light-emitting elements and the other light-emitting element based on the control signal including the applied voltage value.
<10> The communication system according to <5>, wherein the transmission signal has a predetermined number of continuous signals from a predetermined time among signals in which the signal strength changes continuously over time.
11> The communication system according to <10>, wherein the predetermined number corresponds to the number of the plurality of light-emitting elements.
<12> The communication system according to <1>, wherein the snapshot-type spectroscopic camera outputs the optical spectrum as a three-dimensional spectral image data set (data cube), and
the restoration unit extracts the optical spectrum at a position of the light-emitting unit from the three-dimensional spectral image data set (data cube), and restores the transmission signal based on the light emission intensities in the wavelength bands respectively corresponding to the plurality of light-emitting elements in the extracted optical spectrum.
<13> A method of operating a communication system including a transmission unit and a reception unit,
wherein the transmission unit includes:
a light-emitting unit that has a plurality of light-emitting elements that emit light in different wavelength bands, the light-emitting unit controlling light emission of the plurality of light-emitting elements; and
a signal generation unit that generates as a control signal a signal to control the light emission of the plurality of light-emitting elements based on a transmission signal and supplies the control signal to the light-emitting unit, and the reception unit includes:
a snapshot-type spectroscopic camera that detects an optical spectrum of light emitted by the light-emitting unit; and
a restoration unit that restores the transmission signal based on light emission intensities in wavelength bands respectively corresponding to the plurality of light-emitting elements in the optical spectrum detected by the snapshot-type spectroscopic camera,
wherein a method of operating the transmission unit includes: generating, by the signal generation unit, as a control signal a signal to control the light emission of the plurality of light-emitting elements based on the transmission signal, and supplying the control signal to the light-emitting unit; and
controlling, by the light-emitting unit, light emission of the plurality of light-emitting elements based on the control signal, and
wherein a method of operating the reception unit includes: detecting, by the snapshot-type spectroscopic camera, an optical spectrum of light emitted by the light-emitting unit; and
restoring, by the restoration unit, the transmission signal based on light emission intensities in wavelength bands respectively corresponding to the plurality of light-emitting elements in the optical spectrum detected by the snapshot-type spectroscopic camera.

### Reference Signs List

101 Visible light communication system
111 Transmission unit
112 Reception unit
121 Encoding processing unit
122 Light-emitting unit
141 Snapshot-type spectroscopic camera
142 Decoding processing unit
201 Visible light communication system
211 Transmission unit
212 Reception unit
221 Signal conversion unit
222 Light-emitting unit
241 Snapshot-type spectroscopic camera
242 Signal restoration unit

1. A communication system comprising a transmission unit and a reception unit, wherein
the transmission unit includes:
a light-emitting unit that has a plurality of light-emitting elements that emit light in different wavelength bands, the light-emitting unit controlling light emission of the plurality of light-emitting elements; and
a signal generation unit that generates as a control signal a signal to control the light emission of the plurality of light-emitting elements based on a transmission signal and supplies the control signal to the light-emitting unit, and
the reception unit includes:
a snapshot-type spectroscopic camera that detects an optical spectrum of light emitted by the light-emitting unit; and
a restoration unit that restores the transmission signal based on light emission intensities in wavelength bands respectively corresponding to the plurality of light-emitting elements in the optical spectrum detected by the snapshot-type spectroscopic camera.

2. The communication system according to claim 1, wherein
the signal generation unit encodes a signal strength of the transmission signal into an encoded signal made up of a binary bit string with a predetermined number of bits, and supplies the encoded signal to the light-emitting unit as the control signal,
the restoration unit converts the light emission intensities in the wavelength bands respectively corresponding to the plurality of light-emitting elements in the optical spectrum into a binary bit string corresponding to the encoded signal through comparison with a predetermined threshold value, and restores the signal strength of the transmission signal based on the binary bit string.

3. The communication system according to claim 2, wherein the transmission signal has the signal strength at a predetermined time among signals in which the signal strength changes continuously over time.

4. The communication system according to claim 2, wherein the predetermined number of bits corresponds to the number of the plurality of light-emitting elements.

5. The communication system according to claim 1, wherein
the signal generation unit converts a signal strength of the transmission signal into applied voltage values for causing the plurality of light-emitting elements to emit light with corresponding light emission intensities, and supplies the applied voltage values to the light-emitting unit as the control signal,
the light-emitting unit controls the light emission intensities of the plurality of light-emitting elements based on the control signal including the applied voltage values, and
the restoration unit restores the signal strength of the transmission signal based on light emission intensities in the plurality of wavelength bands respectively corresponding to the plurality of light-emitting elements in the optical spectrum.

6. The communication system according to claim 5, wherein
the light-emitting unit further includes another light-emitting element that always emits light with a predetermined light emission intensity in a wavelength band different from the plurality of light-emitting elements, and
the restoration unit corrects, based on the light emission intensity in the wavelength band of the other light-emitting element, an attenuation occurring in the light emission intensities in the plurality of wavelength bands respectively corresponding to the plurality of light-emitting elements in the optical spectrum, and restores the signal strength of the transmission signal based on the corrected light emission intensities in the plurality of wavelength bands.

7. The communication system according to claim 6, wherein the restoration unit calculates a correction coefficient based on the light emission intensity in the wavelength band of the other light-emitting element in the optical spectrum, and corrects the light emission intensities in the plurality of wavelength bands in the optical spectrum by multiplication by the calculated correction coefficient, and restores the signal strength of the transmission signal based on the corrected light emission intensities in the plurality of wavelength bands.

8. The communication system according to claim 7, wherein the restoration unit calculates the correction coefficient by dividing the predetermined light emission intensity by the light emission intensity in the wavelength band of the other light-emitting element in the optical spectrum.

9. The communication system according to claim 6, wherein
the signal generation unit supplies to the light-emitting unit the control signal including an applied voltage value for causing the other light-emitting element to emit light with the predetermined light emission intensity, and
the light-emitting unit controls the light emission intensities of the plurality of light-emitting elements and the other light-emitting element based on the control signal including the applied voltage value.

10. The communication system according to claim 5, wherein the transmission signal has a predetermined number of continuous signals from a predetermined time among signals in which the signal strength changes continuously over time.

11. The communication system according to claim 10, wherein the predetermined number corresponds to the number of the plurality of light-emitting elements.

12. The communication system according to claim 1, wherein
the snapshot-type spectroscopic camera outputs the optical spectrum as a three-dimensional spectral image data set (data cube), and
the restoration unit extracts the optical spectrum at a position of the light-emitting unit from the three-dimensional spectral image data set (data cube), and restores the transmission signal based on the light emission intensities in the wavelength bands respectively corresponding to the plurality of light-emitting elements in the extracted optical spectrum.

13. A method of operating a communication system comprising a transmission unit and a reception unit,
wherein the transmission unit includes:
a light-emitting unit that has a plurality of light-emitting elements that emit light in different wavelength bands, the light-emitting unit controlling light emission of the plurality of light-emitting elements; and
a signal generation unit that generates as a control signal a signal to control the light emission of the plurality of light-emitting elements based on a transmission signal and supplies the control signal to the light-emitting unit, and the reception unit includes:
a snapshot-type spectroscopic camera that detects an optical spectrum of light emitted by the light-emitting unit; and
a restoration unit that restores the transmission signal based on light emission intensities in wavelength bands respectively corresponding to the plurality of light-emitting elements in the optical spectrum detected by the snapshot-type spectroscopic camera,
wherein a method of operating the transmission unit includes:
generating, by the signal generation unit, as a control signal a signal to control the light emission of the plurality of light-emitting elements based on the transmission signal, and supplying the control signal to the light-emitting unit; and
controlling, by the light-emitting unit, light emission of the plurality of light-emitting elements based on the control signal, and
wherein a method of operating the reception unit includes:
detecting, by the snapshot-type spectroscopic camera, an optical spectrum of light emitted by the light-emitting unit; and
restoring, by the restoration unit, the transmission signal based on light emission intensities in wavelength bands respectively corresponding to the plurality of light-emitting elements in the optical spectrum detected by the snapshot-type spectroscopic camera.
